(19) United States
(12) Patent Application Publication
(10) Pub. No.: US 2024/0102362 A1
(43) Pub. Date: Mar. 28, 2024

(54) SYSTEM FOR OBTAINING A PHYSICS-GUIDED BIT WEAR MODEL AND RELATED METHODS

(71) Applicant: Baker Hughes Oilfield Operations LLC, Houston, TX (US)

(72) Inventors: Xu Huang, Spring, TX (US); John Abhishek Raj Bomidi, Peral River, NY (US); Trieu Phat Luu, Houston, TX (US)

(21) Appl. No.: 18/474,938

(22) Filed: Sep. 26, 2023

Related U.S. Application Data
(60) Provisional application No. 63/377,226, filed on Sep. 27, 2022.

(51) Int. Cl. E21B 41/00; E21B 12/02; E21B 45/00; G06F 30/27; G08B 21/18

(52) U.S. Cl. CPC E21B 41/00; E21B 12/02; E21B 45/00; G06F 30/27; G08B 21/18; G06F 2111/10

(57) ABSTRACT

An earth-boring tool system may include a drill string, and at least one or more sensors. The earth-boring tool system may receive data indicative of wear of at least part of a drilling tool, obtain labeled dull grading data for the drilling tool based on the received data, obtain a physics-based bit wear model based on one or more drilling parameters, generate one or more physics-based dull grading data labels based on the physics-based bit wear model, and train an artificial intelligence bit wear model based on the labeled dull grading data and the physics-based dull grading labels.

### CROSS-REFERENCE TO RELATED APPLICATION

This application claims the benefit under 35 U.S.C. § 119(e) of U.S. Provisional Patent Application Ser. No. 63/377,226, filed Sep. 27, 2022, the disclosure of which is hereby incorporated herein in its entirety by this reference.

### TECHNICAL FIELD

Embodiments of the present disclosure relate generally to systems and methods for developing physics-guided predictive bit wear models for earth-boring tools.

### BACKGROUND

Wellbores are formed in subterranean formations for various purposes including, for example, extraction of oil and gas from the subterranean formation and extraction of geothermal heat from the subterranean formation. Wellbores may be formed in a subterranean formation using earth-boring tools, such as an earth-boring rotary drill bit. The earth-boring rotary drill bit is rotated and advanced into the subterranean formation. As the earth-boring rotary drill bit rotates, the cutting elements, cutters, or abrasive structures thereof cut, crush, shear, and/or abrade away the formation material to form the wellbore.

The earth-boring rotary drill bit is coupled, either directly or indirectly, to an end of what is referred to in the art as a “drill string,” which comprises a series of elongated tubular segments connected end-to-end that extends into the wellbore from the surface of earth above the subterranean formations being drilled. Various tools and components, including the drill bit, may be coupled together at the distal end of the drill string at the bottom of the wellbore being drilled. This assembly of tools and components is referred to in the art as a “bottom-hole assembly” (BHA).

### BRIEF SUMMARY

Some embodiments of the present disclosure include an earth-boring tool system. The earth-boring tool system may include a drill string comprising at least one drilling tool, one or more sensors configured to sense wear of the at least one drilling tool, at least one processor, and at least one non-transitory computer readable storage medium storing instructions thereon that, when executed by the at least one processor, cause the earth-boring tool system to receive data indicative of wear of at least part of the at least one drilling tool via the one or more sensors, obtain labeled dull grading data for the at least one drilling tool based, at least in part, on the received data, obtain a physics-based bit wear model based, at least in part, on one or more drilling parameters, the physics-based bit ear model defining a relationship between a wear progress of at least one drilling tool and a drilling depth of the at least one drilling tool, generate one or more physics-based dull grading data labels based, at least in part, on the physics-based bit ear model, and train an artificial intelligence (AI) bit wear model based, at least in part, on the labeled dull grading data and the generated one or more physics-based dull grading data labels.

Further embodiments of the present disclosure include a method for generating a bit wear model. The method may include receiving data indicative of wear of at least one drilling tool based, at least in part, on the received data, obtaining a physics-based bit wear model based, at least in part, on one or more drilling parameters, the physics-based bit wear model defining a relationship between a wear progress of at least one drilling tool and a drilling depth for the at least one drilling tool, generating one or more physics-based dull grading labels based, at least in part, on the physics-based bit wear model, training an artificial intelligence (AI) bit wear model based, at least in part, on the labeled dull grading data and the generated one or more physics-based dull grading data labels.

Further embodiments of the present disclosure may include a non-transitory computer readable storage medium storing instructions thereon that, when executed by the at least one processor, cause the earth-boring tool system to receive data indicative of wear of at least part of the at least one drilling tool via the one or more sensors, obtain labeled dull grading data for the at least one drilling tool based, at least in part, on the received data, obtain a physics-based bit wear model based, at least in part, on one or more drilling parameters, the physics-based bit ear model defining a relationship between a wear progress of at least one drilling tool and a drilling depth of the at least one drilling tool, generate one or more physics-based dull grading data labels based, at least in part, on the physics-based bit ear model, and train an artificial intelligence (AI) bit wear model based, at least in part, on the labeled dull grading data and the generated one or more physics-based dull grading data labels.

### BRIEF DESCRIPTION OF THE SEVERAL VIEWS OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a schematic view of an example earth-boring tool system according to one or more embodiments of the present disclosure;

FIG. 2 is a flowchart illustrating an operation of the earth-boring tool system performed by a processor executing instructions stored on a computer-readable storage medium according to one or more embodiments of the present disclosure;

FIG. 3 shows a diagram of an example machine learning diagram that may be used by the earth-boring tool system according to one or more embodiments of the present disclosure;

FIG. 4 shows a method diagram for obtaining a physics-based bit wear model according to one or more embodiments of the present disclosure;

FIG. 5 is a diagram illustrating an AI bit wear prediction model before and after incorporating data derived from a physics-based bit wear model according to one or more embodiments of the present disclosure;

FIG. 6 is a block diagram of circuitry that, in some examples, may be used to implement various functions, operations, acts, processes, and/or methods disclosed herein.

### DETAILED DESCRIPTION

Downhole drilling operations may involve the use of an earth-boring tool at the end of a long string of pipe commonly referred to as a drill string. An earth-boring tool may be used for drilling through subterranean formations, such as rock, dirt, sand, tar, etc. In some cases, the earth-boring tool may be configured to drill through additional elements that may be present in a wellbore, such as cement, casings (e.g., a wellbore casing), discarded or lost equipment (e.g., fish, junk, etc.), packers, etc. Each element will cause various parts of the earth-boring tool to wear or break down from the act of drilling through them. As various parts of the earth-boring tool wears down, it becomes increasingly likely that at least a part of the earth-boring tool will break, which may sometimes lead to part of, or all of an earth-boring tool being dislodged from the drill string and becoming irretrievably lost within the wellbore. This may result in significant losses of time as well as the loss expensive equipment which may both reduce the efficiency of the drilling operation and require complete replacement of expensive drilling equipment.

To prevent earth-boring tools from wearing down to the point of breaking within a wellbore, a machine learning based bit wear model may be provided to predict the wear of an earth-boring tool so that the tool can be repaired or replaced before breaking within a wellbore. Moreover, by creating a bit wear model, various operating parameters of the drill string may be optimized to reduce wear on the earth-boring tool during operation and maximize the drilling distance of the earth-boring tool before at least part of the earth-boring tool must be repaired or replaced. Typically, this bit wear model may be created by using field data collected from real-time field trials. However, because of physical constraints, it is difficult to measure the wear of an earth boring tool outside of the first few feet of the wellbore. Thus, for a run with several hundreds or thousands of feet of drilling distance, the measured field data may be limited to the initial and final few feet of the entire drilling operation. For example, field data is typically limited to a sharp beginning state of the earth-boring tool (e.g., the first few feet when the earth-boring tool drills into the earth) and an end dull state (e.g., the last few feet after the drill has bored into the earth and is being removed from the wellbore). Moreover, the field data may exhibit large amounts of noise (e.g., sharp variations in detected wear) or be of poor quality (e.g., may exhibit inaccuracies in measurements) which may lead to an inconsistent bit wear model that jumps between sharp and dull prediction states over the predicted length of the wellbore hole making it difficult to predict wear or to optimize various parameters of the drill string to maximize efficiency of the drilling operation.

In accordance with this disclosure, an earth-boring tool system may use a machine-learning based bit wear model for predicting the wear of an earth-boring tool by combining data obtained from acquired field data with data obtained from a physics-based bit wear model derived from physics-based simulations of an operation of a drill string. Furthermore, the earth-boring tool system may also weight the data obtained from the acquired field data and/or the data obtained from the physics-based bit wear model to more accurately simulate downhole conditions for a particular drilling operation. Because the earth-boring tool system of the present disclosure is able to use data derived from acquired field data as well a physics-based bit wear model, the earth-boring tool system is advantageous over conventional bit wear model generation systems. For instance, because the earth-boring tool system may combine the field data with the data obtained from the physics-based wear model, a more robust wear model may be generated that takes into consideration physical realities of wear over distance and time in addition to data acquired from actual operation of a drill string including the earth-boring tool. Thus, when field data is sparse or of poor quality, the data obtained from the physics-based bit wear model may accurately estimate or predict unknown wear states of the earth-boring tool that are missing from the field data in order to generate a more accurate wear prediction model. This more accurate wear prediction model may allow for more stable and reliable predictions that may allow for more efficient drilling operations and prevent loss of expensive down-hole equipment.

Stated another way, the earth-boring tool system of the present disclosure is advantageous over conventional earth-boring tool systems because the earth-boring tool system enables an AI bit wear model to be trained based on measured field data as well as physics-based modeling of a wear vs depth relationship curve to increase the accuracy of the AI bit wear model. For instance, labeled data derived from the physics-based bit wear model will always show the wear increasing as drilling progresses. Accordingly, the labeled data derived from the physics-based bit wear model improves model stability as measured data may be sparse or inaccurate. As a specific non-limiting example, the labeled data derived from the physics-based bit wear model may reduce the chances for an AI bit wear model trained with the physics-based labeled data to show a decrease in wear as drilling progresses. Moreover, by deriving labeled data from a physics-based bit wear model, the dataset for training the AI bit wear model significantly increases in size, which may lead to a more accurate and detailed model. Accordingly, because of the increased accuracy of the model, the earth-boring tool system may optimize one or more drilling parameters based on the AI bit wear model to increase the performance of one or more drilling tools included in the earth-boring tool system. For instance, the earth-boring tool system may optimize various parameters of one or more drilling tools to enable to drilling tools to increase the amount of time a drilling tool is able to perform before the tool must be repaired or replaced due to wear caused by the operation of the drilling tool compared to conventional systems. Moreover, the addition of data derived from the physics-based bit wear model may reduce the amount of field data needed to be measured and/or sensed in order to create a reasonably accurate and/or usable bit wear model and thus make the process of creating a bit wear prediction model of the earth-boring tool system faster compared to conventional systems.

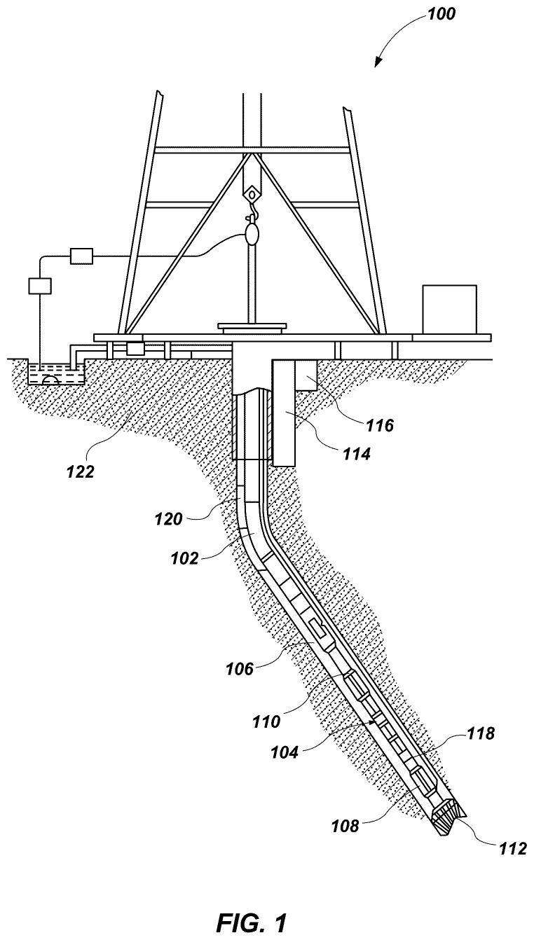

FIG. 1 illustrates an earth-boring tool system 100 according to one or more embodiments of the present disclosure. An earth-boring tool system 100 may include a drill string 102. The earth-boring tool system 100 may also include electronics, such as sensors 114, sensor modules 116, and/or tool control components 118. The drill string 102 may include multiple sections of drill pipe coupled together to form a long string of drill pipe. A forward end of the drill string 102 may include a bottom hole assembly (BHA) 104. The BHA 104 may include components, such as a motor 106 (e.g., mud motor), one or more reamers 108 and/or stabilizers 110, and an earth-boring tool 112 such as a drill bit. The drill string 102 may be inserted into a borehole 120. The borehole 120 may be formed by the earth-boring tool 112 as the drill string proceeds through a formation 122. The tool control components 118 may be configured to control an operational aspect of the earth-boring tool 112. For example, the tool control components 118 may include a steering component configured to change an angle of the earth-boring tool 112 with respect to the drill string 102 changing a direction of advancement of the drill string 102. The tool control components 118 may be configured to receive instructions from an operator at the surface and perform actions based on the instructions. In some embodiments, control instructions may be derived downhole within the tool control components 118, such as in a closed loop system, etc.

The sensors 114 may be configured to collect information regarding the earth-boring tool 112, such as tool temperature, cutter temperature, cutter wear, weight on bit (WOB), torque on bit (TOB), string rotational speed (RPM), and the wear (e.g., degradation, dulling, or damage) of at least part of the earth-boring tool 112. The information collected by the sensors 114 may be processed, stored, and/or transmitted by the sensor modules 116. For example, the sensor modules 116 may receive the information from the sensors 114 in the form of raw data, such as a voltage (e.g., 0-10 VDC, 0-5 VDC, etc.), an amperage (e.g., 0-20 mA, 4-20 mA, etc.), or a resistance (e.g., resistance temperature detector (RTD), thermistor, etc.). The sensor module 116 may process raw sensor data and transmit the data to the surface on a communication network, using a communication network protocol to transmit the raw sensor data. The communication network may include, for example a communication line, mud pulse telemetry, electromagnetic telemetry, wired pipe, etc. In some embodiments, the sensor module 116 may be configured to run calculations on raw sensed data such as, for example, calculating various signs of wear and/or damage to the earth-boring tool 112 relative to a known undamaged, unworn, or initial state of the earth-boring tool 112.

Though shown in FIG. 1 as being located at or near the mouth of the wellbore, the sensors 114 may be located anywhere (e.g., anywhere on the wellbore or located directly on the drill string 102 or the earth-boring tool 112) such that the sensors are able to detect wear of at least part of at least one drilling tool (e.g., earth-boring tool 112).

In some embodiments, the downhole information may be transmitted to the operator at the surface or to a computing device at the surface. For example, the downhole information may be provided to the operator through a display, a printout, etc. In some embodiments, the downhole information may be transmitted to a computing device that may process the information and provide the information to the operator in different formats useful to the operator. For example, measurements that are out of range may be provided in the form of alerts, warning lights, alarms, etc., some information may be provided live in the form of a display, spreadsheet, etc., whereas other information that may not be useful until further calculations are performed may be processed and the result of the calculation may be provided in the display, print out, spreadsheet, etc. In some embodiments, the sensor 114 may be configured to capture image data representative of various parts of the earth-boring tool 112 and provide the image data to the display. An operator may then manually measure, calculate, or otherwise obtain wear parameters of the earth-boring tool 112 based on the provided image data or other data collected by the sensor 114.

In some embodiments, the information sensed by the sensor 114 may be used to generate one or more bit wear models indicative of the predicted wear states of the earth-boring tool 112 over distance drilled in the formation 122. In some embodiments, the one or more bit wear models may be used to determine when at least part of the earth-boring tool 112 should be repaired or replaced. In additional embodiments, the one or more bit wear models may be used to optimize various operating parameters of the drill string for a drilling operation. For example, the earth-boring tool system 100 may automatically adjust one or more drilling parameters including, but not limited to, one or more of rate of penetration (ROP), drilling fluid flow rate, weight on bit (WOB), rotations per minute (RPM), well geometry, drilling fluid composition, etc., responsive to the generated bit wear model. In additional embodiments, the earth-boring tool system 100 may provide to the display one or more recommendations for changes to one or more drilling parameters responsive to the generated bit wear model. An operator may then approve one or more of the one or more recommendations or may manually change one or more drilling parameters based, at least part, on the recommendations.

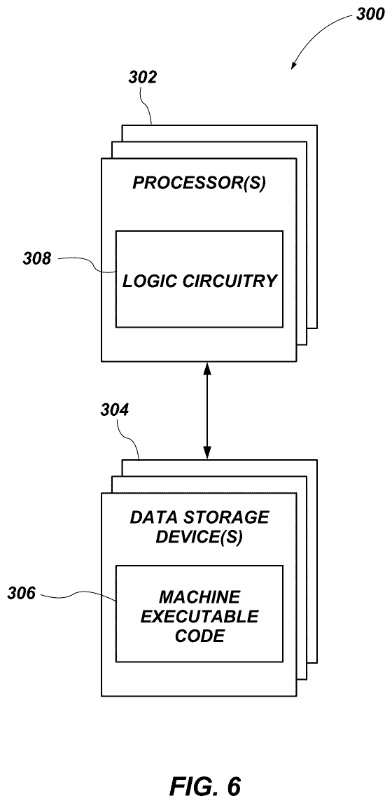

The earth-boring tool system 100 may also include a processor and memory (discussed in more detail with regard to FIG. 6). Additionally, the earth-boring tool system 100 may also include an I/O interface and a communication interface. In one or more embodiments, the processor includes hardware for executing instructions, such as those making up a computer program. The memory may be used for storing data, metadata, and programs for execution by the processor(s). The I/O interface allows a user to provide input to, receive output from, and otherwise transfer data to and receive data from the earth-boring tool system 100 (e.g., to and from sensor 114 via sensor module 116). The communication interface can include hardware, software, or both. In any event, the communication interface can provide one or more interfaces for communication (such as, for example, packet-based communication) between the earth-boring tool system 100 and one or more other computing devices or networks.

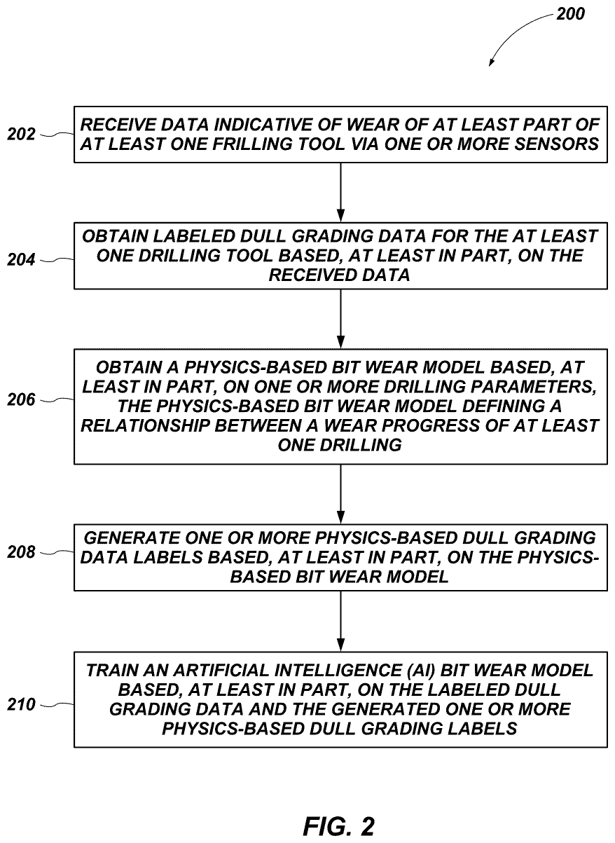

FIG. 2 is a flowchart illustrating an operation of the earth-boring tool system 100 performed by a processor executing instructions stored on a computer-readable storage medium. At operation 202, the earth-boring tool system 100 receives data indicative of wear of the at least part of at least one drilling tool via one or more sensors (e.g., sensor 114). For example, the one or more sensors maybe disposed along the length of a wellbore such that, when a drilling tool (e.g., earth-boring tool 112) passes through or is retrieved from the wellbore, the one or more sensors may capture or otherwise obtain data indicative of wear of at least part of the drilling tool. The one or more sensors may also be disposed on the drilling tool or on other parts included in the earth-boring tool system 100 so long as the one or more sensors are able to detect wear of at least part of at least one drilling tool (e.g., earth-boring tool 112). In some embodiments, the one or more sensors may capture image data of the drilling tool and communicate (e.g., via sensor module 116), the image data to an operator. In some embodiments the one or more sensors may be configured to measure the wear state of the drilling tool relative to a known undamaged, unworn, or initial state of the drilling tool. In some embodiments, the data indicative of wear may be acquired manually. For example, an operator may measure the wear of a drilling tool at various points during a drilling operation. The operator may then provide to the earth-boring tool system 100 with the data the operator collected in the form of data indicative of wear of at least part of at least one drilling tool.

At operation 204, the earth-boring tool system 100 obtains labeled dull grading data for the at least part of at least one drilling tool based, at least in part, on the received data. For example, the data indicative of wear of at least part of at least one drilling tool may be raw data collected directly from the one or more sensors or from data received from an operator. The data may then be labeled to indicate a wear state for each part of the received data. For example, data received at the beginning of a drilling operation may be labeled indicating a first state of wear of a drilling tool and data received at the end of a drilling operation may be labeled indicating a second state of wear of the drilling tool where the second state of wear is greater (e.g., indicating a greater level of wear of at least part of the drilling tool) than the first state of wear. In some embodiments, the earth-boring tool system 100 may label received data automatically. For example the earth-boring tool system may label the received data based on a partially generated or previously generated bit wear model or another program configured to assess a wear state of at least part of a drilling tool based on the data. In other embodiments, the data may be manually labeled by an operator to indicate a state of wear of at least part of a drilling tool.

At operation 206, the earth-boring tool system 100 obtains a physics-based bit wear model based, at least in part, on one or more drilling parameters, the physics-based bit wear model defining a relationship between a wear progress of at least one drilling tool. In some embodiments, the physics-based bit wear model may be generated by the earth-boring tool system 100 responsive to one or more mathematical simulations of an operation of a drill string. For example, the one or more mathematical simulations may be configured to simulate physics-based operations of a drill string based one or more drilling parameters that include, but are not limited to, one or more of rock strength, rate of penetration (ROP), weight on bit (WOB) rotations per minute (RPM), well geometry, formation geometry, formation density, tool geometry, formation composition, or tool rotation, etc. The one or more drilling parameters may be based, at least in part, on drilling parameters obtained from historical drilling data. For example, the one or more drilling parameter values may be the values that were measured in past drilling operations. The drilling parameters may also be manually entered by an operator based on empirical knowledge of the operator. In some embodiments, the one or more drilling parameters may be field averaged parameters. For example, each drilling parameter of the one or more drilling parameters may be an average of historical drilling parameters obtained from known field data.

Once the mathematical simulations have been calculated, the physics-based bit wear model may be trained using machine learning a suitable machine learning technique (e.g., any machine learning technique discussed herein) where the one or more mathematical simulations may be used to train the physics-based bit wear model. For example, in some embodiments the physics-based bit wear model may be trained using supervised machine learning by using the labeled dull grading data. In additional embodiments, the bit wear model may be trained using decision tree learning, regression trees, boosted trees, gradient boosted trees, multilayer perceptron, one-vs-rest, gradient boosted tree, k-nearest neighbor association rule learning, a neural network, deep learning, pattern recognition, or any other type of machine learning. In some embodiments, the AI bit wear model may be generated by the earth-boring tool system 100. In other embodiments, an already generated AI bit wear model may be retrieved (e.g., from a storage device included in the earth-boring tool system 100) or otherwise obtained by the earth-boring tool system 100. In some embodiments, the earth-boring tool system 100 may obtain a physics-based bit wear model that has already been generated. For example, the earth-boring tool system 100 may retrieve a generated physics-based bit wear model that has been stored on a storage device included in or external to the earth-boring tool system 100.

The physics-based bit wear model may be configured to define a wear vs depth curve that defines a relationship between the wear progress of a drilling tool and the drilling depth of the drilling tool. For example, in some embodiments, one or more drilling parameters (e.g., field averaged parameters) may be input to the physics-based bit-wear model to define a predicted wear progress over drilling depth relationship based on the input drilling parameters. At operation 210, the earth-boring tool system 100 may then generate one or more physics-based dull grading data labels that are based, at least in part, on the physics-based bit wear model. For example, the earth-boring tool system 100 may apply the wear vs depth relationship curve obtained from the physics-based bit wear model to the unknown dull states of the AI bit wear model to calculate dull grading data labels for these unknown states. In some embodiments, the earth-boring tool system 100 may assign weights to one or more of the labeled dull grading data and/or the physics-based dull grading data labels. For example, the earth-boring tool system 100 may assign weights to the data based on historical drilling data, known dull grading data labels, or detected uncertainties or errors in the physics-based bit wear model. The weights may also be assigned manually by an operator. For example, an operator may assign weights to one or more of the labeled dull grading data and/or one or more of the physics-based dull grading data labels based on his or her own empirical knowledge (e.g., knowledge a formation to be drilled for which a bit wear prediction model is being generated or knowledge of uncertainties or errors in the physics-based bit wear model).

In some embodiments, the wear progress vs drilling depth curve may be extracted from the physics-based bit wear model through a statistical analytic model such as machine learning models (e.g., statistical computing), linear models (e.g., linear regression, logistic regression, Poisson regression, etc.), multilevel models (e.g., hierarchical linear models, nested data models, mixed models, random coefficient, random-effects models, random parameter models, split-plot designs, etc.), linearization (e.g., quadratic regression, logarithmic regression, exponential regression, trigonometric regression, power function regression, Gaussian regression, Lorenz regression, a support vector machine, ensemble models, etc.), segmentation (e.g., separate linear regression models for each segment of data, or local regression), curve fitting, least square (e.g., linear least squares, non-linear least squares, etc.), classification models, and/or phenomena models. However, any conventionally known method of extracting a relationship curve from a model may be used to extract the wear progress vs drilling depth curve from the physics-based bit wear model.

At operation 210, the earth-boring tool system 100 trains an artificial intelligence (AI) bit wear model based, at least in part, on the labeled dull grading data and the generated one or more physics-based dull grading data labels. The AI bit wear model may be trained using any suitable machine learning techniques (e.g., any machine learning technique disclosed herein). Additionally, the labeled dull grading data and the generated one or more physics-based dull grading data labels may be used together as part of the same training data set to train the AI bit wear model. For example, the generated one or more physics-based dull grading data labels may be used where dull-grading data is absent in the labeled dull grading data based on the data received via the one or more sensors. Accordingly, the physics-based labeled dull grading data may supplement the labeled dull grading data based on the received data to train the AI bit wear model and thereby allow for a larger and more complete data set to be used in the model training. In some embodiments, the AI bit wear model may be trained based on unweighted labeled dull grading data and weighted (e.g., adjustably weighted) physics-based dull grading labels.

Additionally, in one or more embodiments the earth-boring tool system 100 may generate a warning indicative of a need to replace at least part of the at least one drilling tool responsive to the AI bit wear model. For example, once the AI bit wear model has been trained using the labeled dull grading data derived from the data received via the one or more sensors and the data derived from the physics-based bit wear model, the AI bit wear model may predict the wear of one or more drilling tools (e.g., a drilling tool about to be used in a down-hole drilling operation). Accordingly, the AI bit wear model may predict a depth at which one or more drilling tools is at increased risk of breaking or when at least one of the one or more drilling tools needs to be replaced. For example, the earth-boring tool system 100 may detect that one or more drilling tools have reached a depth where the AI bit wear model predicts that the wear of at least one drilling tool (e.g., at least part of earth-boring tool 112) will have surpassed a predetermined threshold for wear. When the earth-boring tool system 100 detects a drilling tool has reached the predicted depth and exceeded the predetermined threshold, the earth-boring tool system 100 may generate a warning indicating that at least part of at least one drilling tool needs to be replaced or repaired. In some embodiments, the earth-boring tool system 100 may then provide to an operator via a display of the earth-boring tool system, the generated warning. In some embodiments, the earth-boring tool system 100 may execute the AI model or both the AI model and a physics-based labeling assistant to generate the warning.

The earth-boring tool system 100 may then automatically change one or more operational drilling parameters of the drill string 102 responsive to detecting the increased risk. For example, the earth-boring tool system 100 may change one or more operational drilling parameters known to values known to reduce the likelihood of damage to at least one drilling tool (e.g., earth-boring tool 112). As a specific non-limiting example, when the earth-boring tool system 100 detects that one or more drilling tools has reached a depth where the AI bit wear model predicts that the wear of at one or more drilling tools will have crossed a predetermined threshold, the earth-boring tool system may cease drilling operations unless overridden by an operator. For example, the warning displayed to an operator may include a selectable option to override the warning where, if the warning is not overridden, the earth-boring tool system 100 may cease operations after a predetermined length of time has elapsed. If, however, the operator selects the override option before expiration of the predetermined length of time, the earth-boring tool system 100 may continue operation uninterrupted. The earth-boring tool system 100 may also display with the warning a selectable option to immediately cease drilling operations or to modify one or more drilling operations. Furthermore, the earth-boring tool system 100 may also present, with the warning, one or more recommendations. For example, the one or more recommendations may recommend changing one or more operational drilling parameters of the drill string 102 as well as recommended values. An operator may then, upon selecting the option to modify the operational drilling parameters of the drill string, select to implement the recommended values or manually input different values.

Furthermore, in one or more embodiments, after the AI bit wear model has been trained using labeled dull grading data derived from both data received via one or more sensors and a wear progress over drilling depth relationship curve, the AI bit wear model may then be validated using cross-validation testing. The results of the cross validation testing may then be verified using varied training and/or testing datasets. For example, the AI bit wear model may be verified using historical drilling tool wear data.

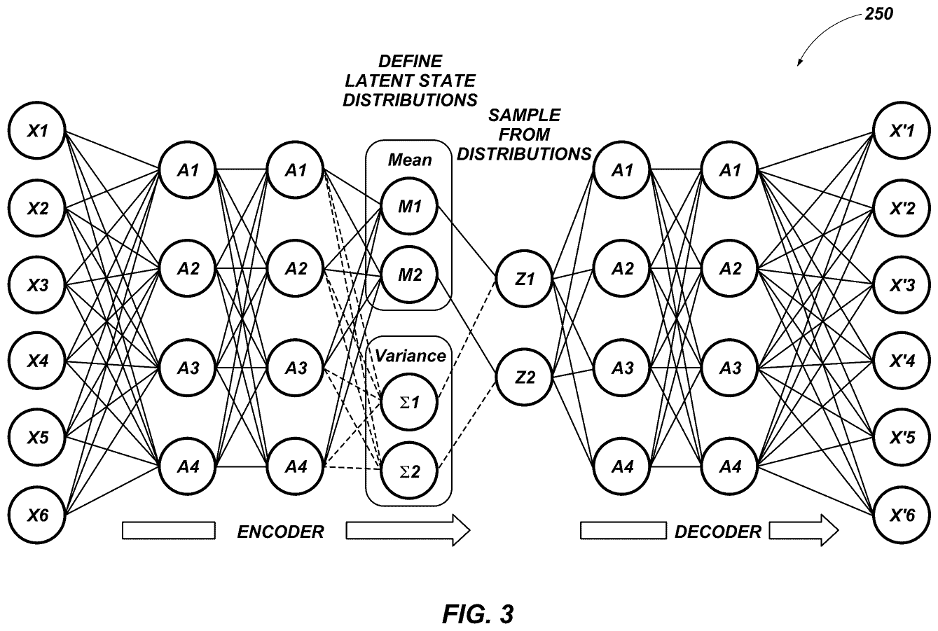

FIG. 3 is an illustration of an example encoder/decoder machine learning method 250 for generating or training an AI bit wear model. For example, the encoder/decoder method for machine learning enables the AI bit wear model to receive field input data (e.g., data received by the one or more sensors) and capture the features and details from that data to predict the wear of one or more drilling tools as a function of the distance (e.g., depth) that the one or more drilling tools have bored into a formation. Though shown in FIG. 3 as using an encoder/decoder machine learning method, the earth-boring tool system 100 of the present disclosure is not so limited. Accordingly, as discussed above with regard to FIG. 2, any machine learning method may be used so long as the earth-boring tool system 100 is able to receive data indicative of wear of at least part of one or more drilling tools and generate or train an AI bit wear model using the data to predict the wear of the one or more drilling tools as a function of distance the one or more drillings tools have bored into a formation (e.g., a rock formation).

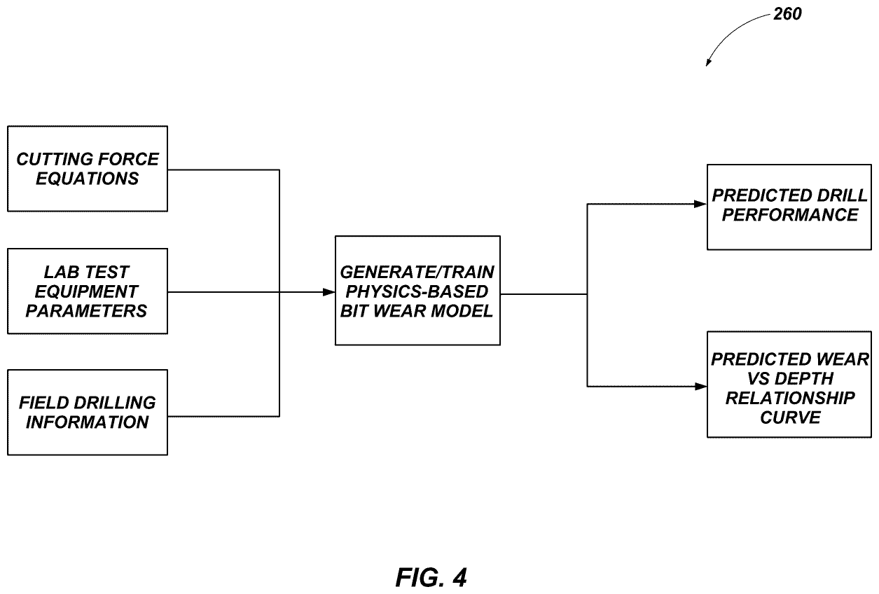

FIG. 4 is an illustration of an example method 260 of generating a physics-based bit wear model. For example, as shown in FIG. 4, a physics-based bit wear model may be based on field drilling information (e.g., one or more drilling parameters), defined cutting force equations, parameters derived from lab tested equipment, and other collected data. In some embodiments, one or more of the field drilling information, cutting force equations, and equipment parameters may be used in one or more physics-based mathematical simulations to simulate one or more operations of one or more drilling tools. For example, the mathematical simulations may comprise creating one or more 3d drilling models which may be used to train a physics-based bit wear model based on those 3D drilling models. Accordingly, by using the field drilling information, the defined cutting force equations, equipment parameters derived from lab tested equipment, and/or one or more mathematical simulations, a physics-based bit wear model may be obtained or generated. The physics-based bit wear model may, as a result, model a prediction of progressive wear of one or more drilling tools as a function of distance drilled by the one or more drilling tools based on one or more field drilling information (e.g., variations in downhole rock strength), cutting force equations, and/or equipment parameters (e.g., earth-boring tool geometry). Accordingly, when one or more drilling parameters are input into the physics-based bit wear model, the physics-based bit wear model may define a wear progression vs drilling depth (e.g., drilling distance) relationship curve that predicts the amount of wear as a function of drilling depth for a given set of one or more drilling parameters. The physics-based bit wear model may also predict the expected performance of one or more drilling tools (e.g., how fast/effectively the drilling tool will bore into a given formation).

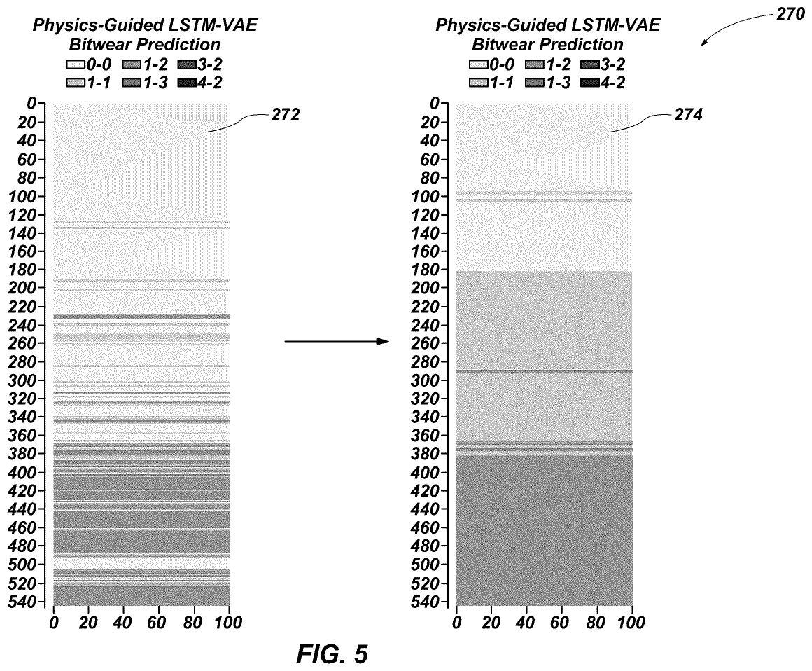

FIG. 5 is a diagram 270 illustrating an AI bit wear prediction model before and after incorporating data derived from a physics-based bit wear model according to one or more embodiments. The diagram includes a first bit wear graph 272 and a second bit wear graph 274 where the first and second bit wear graphs 272 and 274 show a dull grading level of at least one drilling tool as a function of depth in feet. Various levels of sharpness shown in first and second graphs 272 and 274 are indicated by different gradients. Moreover, the gradients correlate with numerical indicators where 0-0 indicates a predicted sharp or unworn state of at least one drilling tool and 4-2 represents a highest predicted wear state of at least one drilling tool. First bit wear graph 272 represents a bit wear prediction derived from an AI bit wear model trained using labeled data derived from field data acquired via one or more sensors of the earth-boring tool system 100. As shown in FIG. 5, graph 272 spare or inaccurate field data may create inconsistencies in the AI bit wear model. For example, graph 272 illustrates the instability that may be exhibited by reliance on field data alone where graph 272 appears to show the wear of at least one drilling tool reversing from a depth of about 490 feet to about 530 feet. Graph 274 represents a bit wear prediction derived from an AI bit wear model trained using both labeled field data and physics-based dull grading labels derived from a physics-based bit wear model. As shown in second bit wear graph 274, the incorporation of physics-based labeled data improves the accuracy of the AI bit wear model and improves model stability (e.g., reduces the chance to have wear decrease in the model prediction).

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 6 illustrates non-limiting examples of implementations of functional elements disclosed herein. In some examples, some or all portions of the functional elements disclosed herein may be performed by hardware specially configured for carrying out the functional elements.

FIG. 6 is a block diagram of circuitry 300 that, in some examples, may be used to implement various functions, operations, acts, processes, and/or methods disclosed herein. The circuitry 300 includes one or more processors 302 (sometimes referred to herein as “processors 302”) operably coupled to one or more data storage devices (sometimes referred to herein as “storage 304”). The storage 304 includes machine executable code 306 stored thereon and the processors 302 include logic circuitry 308. The machine executable code 306 includes information describing functional elements that may be implemented by (e.g., performed by) the logic circuitry 308. The logic circuitry 308 is adapted to implement (e.g., perform) the functional elements described by the machine executable code 306. The circuitry 300, when executing the functional elements described by the machine executable code 306, should be considered as special purpose hardware configured for carrying out functional elements disclosed herein. In some examples the processors 302 may perform the functional elements described by the machine executable code 306 sequentially, concurrently (e.g., on one or more different hardware platforms), or in one or more parallel process streams.

When implemented by logic circuitry 308 of the processors 302, the machine executable code 306 is to adapt the processors 302 to perform operations of examples disclosed herein. For example, the machine executable code 306 may adapt the processors 302 to perform at least a portion or a totality of the operation 200 of FIG. 2. As another example, the machine executable code 306 may adapt the processors 302 to perform at least a portion or a totality of the operations discussed for the system of FIG. 1. As a specific, non-limiting example, the machine executable code 306 may adapt the processors 302 to obtain an AI bit wear model and a physics-based bit wear model. As another non-limiting example, the machine executable code 306 may adapt the processors to obtain labeled dull grading data from data received via one or more sensors as well as physics-based dull grading data derived from the physics-based bit wear model to train the AI bit wear model.

The processors 302 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine executable code 306 (e.g., software code, firmware code, hardware descriptions) related to examples of the present disclosure. It is noted that a general-purpose processor (may also be referred to herein as a host processor or simply a host) may be a microprocessor, but in the alternative, the processors 302 may include any conventional processor, controller, microcontroller, or state machine. The processors 302 may also be implemented as a combination of computing devices, such as a combination of a DSP and a microprocessor, a plurality of microprocessors, one or more microprocessors in conjunction with a DSP core, or any other such configuration.

In some examples the storage 304 includes volatile data storage (e.g., random-access memory (RAM)), non-volatile data storage (e.g., Flash memory, a hard disc drive, a solid state drive, erasable programmable read-only memory (EPROM), etc.). In some examples, the processors 302 and the storage 304 may be implemented into a single device (e.g., a semiconductor device product, a system on chip (SOC), etc.). In some examples the processors 302 and the storage 304 may be implemented into separate devices.

In some examples the machine executable code 306 may include computer-readable instructions (e.g., software code, firmware code). By way of non-limiting example, the computer-readable instructions may be stored by the storage 304, accessed directly by the processors 302, and executed by the processors 302 using at least the logic circuitry 308. Also by way of non-limiting example, the computer-readable instructions may be stored on the storage 304, transferred to a memory device (not shown) for execution, and executed by the processors 302 using at least the logic circuitry 308. Accordingly, in some examples the logic circuitry 308 includes electrically configurable logic circuitry 308.

In some examples the machine executable code 306 may describe hardware (e.g., circuitry) to be implemented in the logic circuitry 308 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description may be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 308 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 306 may include an HDL, an RTL, a GL description, a mask level description, other hardware description, or any combination thereof.

In examples where the machine executable code 306 includes a hardware description (at any level of abstraction), a system (not shown, but including the storage 304) may implement the hardware description described by the machine executable code 306. By way of non-limiting example, the processors 302 may include a programmable logic device (e.g., an FPGA or a PLC) and the logic circuitry 308 may be electrically controlled to implement circuitry corresponding to the hardware description into the logic circuitry 308. Also by way of non-limiting example, the logic circuitry 308 may include hard-wired logic manufactured by a manufacturing system (not shown, but including the storage 304) according to the hardware description of the machine executable code 306.

Regardless of whether the machine executable code 306 includes computer-readable instructions or a hardware description, the logic circuitry 308 is adapted to perform the functional elements described by the machine executable code 306 when implementing the functional elements of the machine executable code 306. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An earth-boring tool system comprising:
a drill string comprising at least one drilling tool;
one or more sensors configured to sense wear of the at least one drilling tool;
at least one processor;
at least one non-transitory computer readable storage medium storing instructions thereon that, when executed by the at least one processor cause the model generation system to:
receive data indicative of wear of at least part of the at least one drilling tool via the one or more sensors;
obtain labeled dull grading data for the at least one drilling tool based, at least in part, on the received data;
obtain a physics-based bit wear model based, at least in part, on one or more drilling parameters, the physics-based bit wear model defining a relationship between a wear progress of at least one drilling tool and a drilling depth of the at least one drilling tool;
generate one or more physics-based dull grading data labels based, at least in part, on the physics-based bit wear model; and
train an artificial intelligence (AI) bit wear model based, at least in part, on the labeled dull grading data and the generated one or more physics-based dull grading data labels.

2. The earth-boring tool system of claim 1, wherein the drilling parameters include one or more of rock strength, rate of penetration (ROP), weight on bit (WOB) rotations per minute (RPM), well geometry, formation geometry, formation density, tool geometry, formation composition, or tool rotation.

3. The earth-boring tool system of claim 1, wherein the one or more drilling parameters are based, at least in part, on field average drilling parameters of historical drilling data.

4. The earth-boring tool system of claim 1, further comprising assigning weights to one or more the labeled dull grading data and/or the one or more physics-based dull grading data labels.

5. The earth-boring tool system of claim 1, wherein the one or more physics-based dull grading data labels are generated responsive to unknown dull states of the at least one drilling tool during a drilling operation.

6. The earth-boring tool system of claim 1, wherein the instructions stored on the at least one computer readable storage medium, when executed by the at least one processor, cause the earth-boring tool system to:
generate a warning indicative of a need to replace at least part of the at least one drilling tool; and
provide to an operator via a display of the earth-boring tool system, the generated warning.

7. The earth-boring tool system of claim 1, wherein the instructions stored on the at least one computer readable storage medium, when executed by the at least one processor, cause the earth-boring tool system to:
verify the AI bit wear model based, at least in part, on historical drilling tool wear data.

8. The earth-boring tool system of claim 1, wherein the instructions stored on the at least one computer readable storage medium, when executed by the at least one processor, cause the earth-boring tool system to:
generate a physics-based bit wear model based, at least in part, on one or more physics-based mathematical simulations of one or more operations of a drill string.

9. A method for obtaining a bit wear model, the method comprising:
receiving data indicative of wear of at least one drilling tool via one or more sensors;
obtaining labeled dull grading data for the at least one drilling tool based, at least in part, on the received data;
obtaining a physics-based bit wear model based, at least in part, on one or more drilling parameters, the physics-based bit wear model defining a relationship between a wear progress of at least one drilling tool and a drilling depth of the at least one drilling tool;
generating one or more physics-based dull grading data labels based, at least in part, on the physics-based bit wear model; and
training an artificial intelligence (AI) bit wear model based, at least in part, on the labeled dull grading data and the generated one or more physics-based dull grading data labels.

10. The method of claim 9, further comprising applying weights to one or more of the labeled dull grading data and/or the one or more physics-based dull grading data labels.

11. The method of claim 9, further comprising verifying the AI bit wear model based, at least in part, on historical drilling tool wear data.

12. The method of claim 9, further comprising generating a physics-based bit wear model based, at least in part, on one or more physics-based mathematical simulations of one or more operations of a drill string.

13. The method of claim 9, wherein the one or more physics-based dull grading data labels are generated responsive to unknown dull states of the at least one drilling tool during a drilling operation.

14. The method of claim 9, wherein the drilling parameters include one or more of rock strength, rate of penetration (ROP), weight on bit (WOB) rotations per minute (RPM), well geometry, formation geometry, formation density, tool geometry, formation composition, or tool rotation.

15. The method of claim 9, further comprising:
generating a warning indicative of a need to replace at least part of the at least one drilling tool; and
providing to an operator via a display of the earth-boring tool system, the generated warning.

16. A non-transitory computer-readable medium storing instructions thereon that, when executed by the at least one processor, cause the at least one processor to perform the steps comprising:
receiving data indicative of wear of the at least on drilling tool via the one or more sensors;
obtaining labeled dull grading data for the at least one drilling tool based, at least in part, on the received data;
obtaining a physics-based bit wear model based, at least in part, on one or more drilling parameters, the physics-based bit wear model defining a relationship between a wear progress of at least one drilling tool and a drilling depth of the at least one drilling tool;
generating one or more physics-based dull grading data labels based, at least in part, on the physics-based bit wear model; and
training an artificial intelligence (AI) bit wear model based, at least in part, on the labeled dull grading data and the generated one or more physics-based dull grading data labels.

17. The non-transitory computer-readable medium of claim 16, wherein the drilling parameters include one or more of rock strength, rate of penetration (ROP), weight on bit (WOB) rotations per minute (RPM), well geometry, formation geometry, formation density, tool geometry, formation composition, or tool rotation.

18. The non-transitory computer-readable medium of claim 16, wherein the one or more drilling parameters are based, at least in part, on field average drilling parameters of historical drilling data.

19. The non-transitory computer-readable medium of claim 16, further comprising assigning weights to one or more of the labeled dull grading data and/or the one or more physics-based dull grading data labels.

20. The non-transitory computer-readable medium of claim 16, wherein the one or more physics-based dull grading data labels are generated responsive to unknown dull states of the at least one drilling tool during a drilling operation.
